(19) United States
(12) Patent Application Publication
(10) Pub. No.: US 2013/0091069 A1
(43) Pub. Date: Apr. 11, 2013

(54) PROCESSING OF ELECTRONIC AIR WAYBILLS ACCORDING TO BILATERAL AGREEMENTS

(71) Applicants: William Loebertmann, Shakopee, MN (US); JoAnn Jancik, Victoria, MN (US)

(72) Inventors: William Loebertmann, Shakopee, MN (US); JoAnn Jancik, Victoria, MN (US)

(21) Appl. No.: 13/271,136

(22) Filed: Oct. 11, 2011

(51) Int. Cl. G06Q 50/28; G06Q 50/30

(52) U.S. Cl. 705/331

(57) ABSTRACT

A logistics management system (LMS) may generate electronic air waybills for a received freight waybill when a bilateral agreement is in place between at least a destination country and a origin country on the freight waybill. Bilateral agreements may also be associated with particular accounts, carriers, or shippers, such that freight waybills processed by an LMS cause the LMS to generate an electronic air waybill when information on the freight waybill matches a bilateral agreement. If no bilateral agreement applies then a paper air waybill may be generated. The bilateral agreements for individual destination countries, origin countries, and accounts may be stored in a database of the LMS, which is searched when processing a freight waybill.

### TECHNICAL FIELD

The instant disclosure relates to logistics management systems. More specifically, the instant disclosure relates to generating electronic air waybills.

### BACKGROUND

The paper air waybill is an air cargo document that constitutes the contract of carriage between a shipper (e.g., direct shipper or freight forwarder acting on behalf of the shipper) and a carrier (e.g., airline). An electronic air waybill, or “e-AWB,” is the term IATA uses to describe the interchange of electronic data (EDI) messages, in lieu of a paper air waybill, to conclude the contract of carriage. The terms and conditions for interchanging EDI messages between a shipper and a carrier are specifically set forth in IATA's Model Agreement for EDI. By removing the requirements for a paper air waybill, IATA has significantly simplified the air freight supply chain process.

The e-AWB Agreement was endorsed by IATA, was adopted by the Cargo Service Conference in 2010, and was approved by several governments around the world including the United States Department of Transportation. However, due to the absence of an electronic air waybill standard, IATA e-freight was implemented with the paper air waybill being exchanged between the shipper and the carrier at origin as evidence of the contract.

Electronic air waybills are preferred by shippers and carriers, and e-AWBs may soon become mandatory for all e-freight shipments on IATA e-freight trade lines. Logistics management systems (LMS) often provide computing resources to process freight shipment data, and attempt to aid in scheduling, coordinating and tracking various aspects of the freight shipment. Thus, logistics management system should be updated to process electronic air waybills for appropriate trade lines.

### SUMMARY

According to one embodiment, a method includes receiving an incoming freight waybill (FWB) message having an origination country and a destination country. The method also includes identifying whether a bilateral agreement exists between the origination country and the destination country. The method further includes, when a bilateral agreement exists, creating an electronic air waybills (e-AWB) for the incoming FWB message.

According to another embodiment, a computer program product includes a non-transitory computer readable medium having code to receive an incoming freight waybill (FWB) message having an origination country and a destination country. The medium also includes code to identify whether a bilateral agreement exists between the origination country and the destination country. The medium further includes code to, when a bilateral agreement exists, create an electronic air waybills (e-AWB) for the incoming FWB message.

According to yet another embodiment, a system includes a memory and at least one processor. The at least one processor is coupled to the memory. The at least one processor is configured to receive an incoming freight waybill (FWB) message having an origination country and a destination country. The at least one processor is also configured to identify whether a bilateral agreement exists between the origination country and the destination country. The at least one processor is further configured to, when a bilateral agreement exists, create an electronic air waybills (e-AWB) for the incoming FWB.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a flow chart illustrating a freight handling process with electronic air waybills according to one embodiment of the disclosure.

FIG. 2 is a flow chart illustrating processing of an incoming freight waybill according to one embodiment of the disclosure.

FIG. 3 is a flow chart illustrating processing of an incoming freight waybill with an override option according to one embodiment of the disclosure.

FIG. 4 is a block diagram illustrating a display for searching bilateral agreements according to one embodiment of the disclosure.

FIG. 5 is a block diagram illustrating a display for listing participant information in bilateral agreements according to one embodiment of the disclosure.

FIG. 6 is a block diagram illustrating a display for listing details of participant information in bilateral agreements according to one embodiment of the disclosure.

FIG. 7 is block diagram illustrating a data management system configured to store databases, tables, and/or records according to one embodiment of the disclosure.

FIG. 8 is a block diagram illustrating a data storage system according to one embodiment of the disclosure.

FIG. 9 is a block diagram illustrating a computer system according to one embodiment of the disclosure.

### DETAILED DESCRIPTION

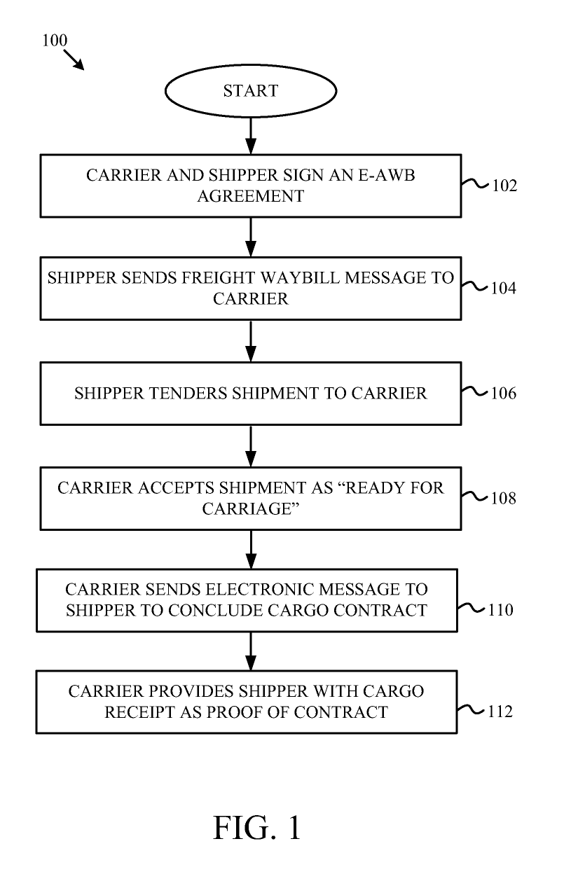

FIG. 1 is a flow chart illustrating a freight handling process with electronic air waybills according to one embodiment of the disclosure. A method 100 begins at block 102 with both parties to a transaction, a carrier and a shipper, signing an electronic air waybill (e-AWB) agreement. The e-AWB agreement may be performed once at a corporate level and applied to all shipments involving the carrier and the shipper along appropriate trade lines. At block 104 the shipper sends a freight waybill (FWB) electronic message, such as an IATA CargoIMP freight waybill message, to the carrier prior to tendering shipment. At block 106 the shipper tenders the shipment to the carrier prior to flight departure. At block 108 the carrier accepts shipment in their management system as “ready for carriage.” At block 110 the carrier sends an electronic message to the shipper, which concludes the cargo contract. At block 112 the carrier provides the shipper with a cargo receipt, such as a paper document, as proof of contract.

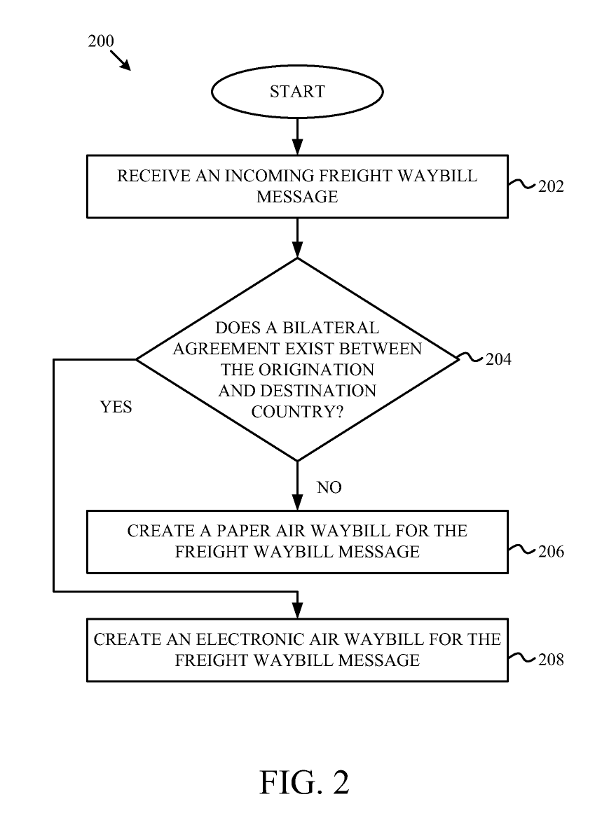

A logistics management system (LMS) may be adapted for handling electronic air waybills. FIG. 2 is a flow chart illustrating processing of an incoming freight waybill according to one embodiment of the disclosure. A method 200 begins at block 202 with receiving an incoming freight waybill. At block 204 it is determined whether a bilateral agreement exists between the origination and destination country of the freight waybill received at block 202. According to one embodiment, a database may be searched to determine if the bilateral agreement exists and/or whether the shipper or carrier on the freight waybill have agreed to exchange of electronic air waybills. The test at block 204 may consider more than the origination and destination countries of the freight waybill. For example, the test at block 204 may also consider the name of the carrier, the name of the shipper, and/or the account number. If a bilateral agreement exists then the method 200 proceeds to block 208 to create an electronic air waybill for the freight waybill received at block 202. If no bilateral agreement exists then the method 200 proceeds to block 206 to create a paper air waybill for the freight waybill received at block 202.

When performing the test at block 204 an effective date may be considered for any bilateral agreement matching the origination and destination countries of the freight waybill. For example, a bilateral agreement may be entered into but not yet effective when an effective date for a bilateral agreement is in the future. Thus, the block 204 may determine no bilateral agreement exists even when a bilateral agreement is found but is not yet effective.

According to one embodiment, the generation of an electronic air waybill at block 208 and the generation of a paper air waybill at block 206 may be triggered by a flag associated with the freight waybill received at block 202. For example, when the block 204 determines no bilateral agreement exists, a parameter (e.g., C$eAWB) may be set to false. When processing is performed later on the freight waybill to complete the contract the paper air waybill may be generated at block 206. In another example, when the block 204 determines a bilateral agreement exists, the parameter may be set to true. When processing is performed later on the freight waybill to complete the contract the electronic air waybill may be generated at block 208.

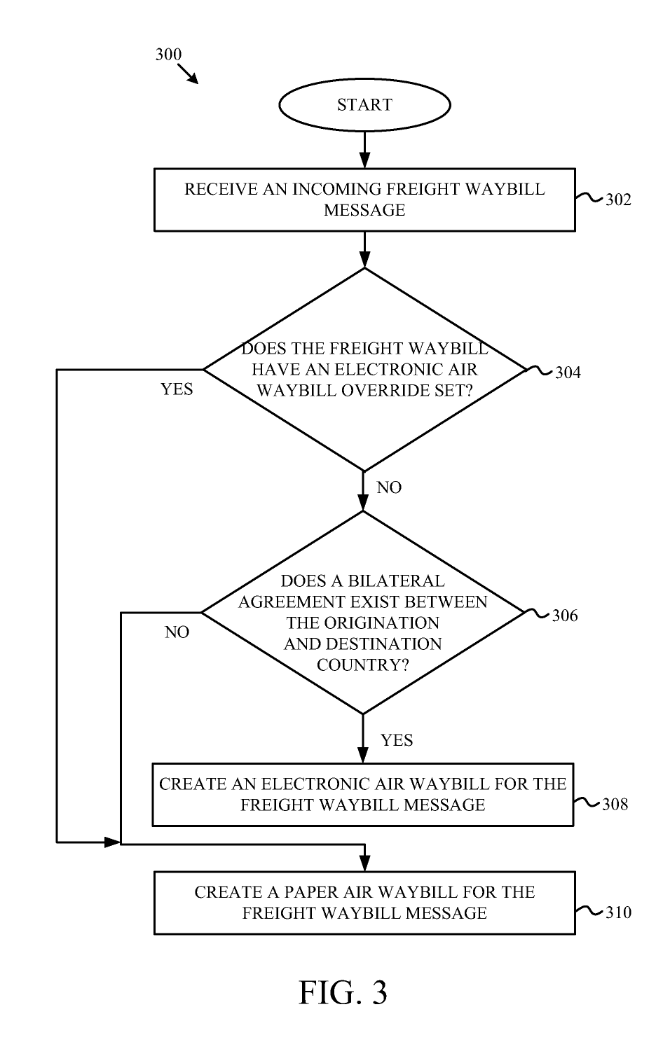

An option may be added to the logistics management system to include an override function that prevents the generation of an electronic air waybill for a particular freight waybill. The override option may be set in the electronic freight waybill. FIG. 3 is a flow chart illustrating processing of an incoming freight waybill with an override option according to one embodiment of the disclosure. A method 300 begins at block 302 with receiving an incoming freight waybill. The freight waybill may have an option to override generation of an electronic air waybill. For example, when the freight waybill is received as an extensible markup language (XML) formatted message, the option may be a true/false value in an additional tag in the XML message. At block 304 it is determined whether the freight waybill received at block 302 includes an indicator to override generation of an electronic air waybill. If the override option is set on the freight waybill received at block 302 then the method 300 continues to block 310 to create a paper air waybill for the freight waybill.

If the override option is not set on the freight waybill received at block 302 then the method continues to block 306. At block 306 it is determined whether a bilateral agreement exists between the origination and destination country for the freight waybill. If a bilateral agreement exists then the method 300 continues to block 308 to create an electronic air waybill for the freight waybill received at block 302. If no bilateral agreement exists then the method 300 continues to block 310 to create a paper air waybill for the freight waybill received at block 302. According to one embodiment, the blocks 304 and 306 may be switched such that the bilateral agreement determination is performed before the override determination.

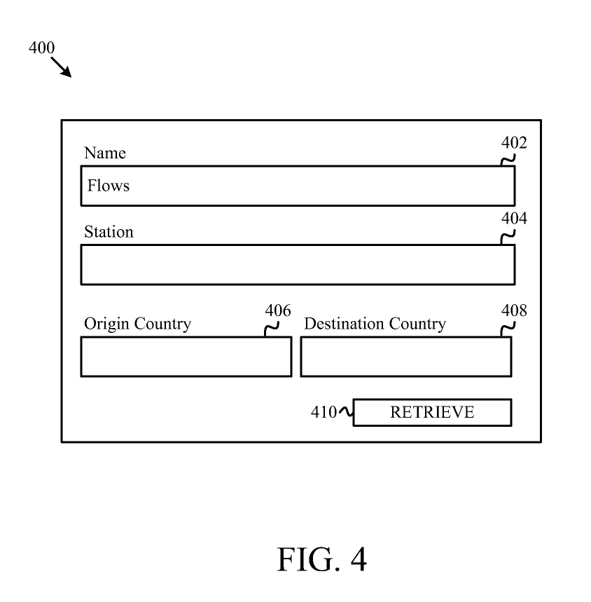

Information about bilateral agreements specifying electronic air waybills for specific trade routes between a destination country and an origination country for particular shippers and/or carriers may be stored in a database. The contents of the database of bilateral agreements may be viewed and modified through an interface on, for example, a client device through a web site. Additionally, entries in the database may be created when new bilateral agreements are signed or deleted when previously-stored bilateral agreements are cancelled. FIG. 4 is a block diagram illustrating a display for searching for bilateral agreements according to one embodiment of the disclosure.

A display 400 may provide an interface for searching for specific bilateral agreements in a database. The display 400 may include a name field 402 for specifying a name or a portion of a name of a party to a bilateral agreement (e.g., the shipper or the carrier). According to one embodiment, the field 402 may also be used to search based on account number or other identification number. The display 400 may also include a station field 404 for filtering results based on a station. According to one embodiment, the station may be a city or airport code. An origin country field 406 and a destination country field 408 may be provided to further filter results. When a retrieve button 410 is clicked search results will be generated matching the input provided to fields 402-408.

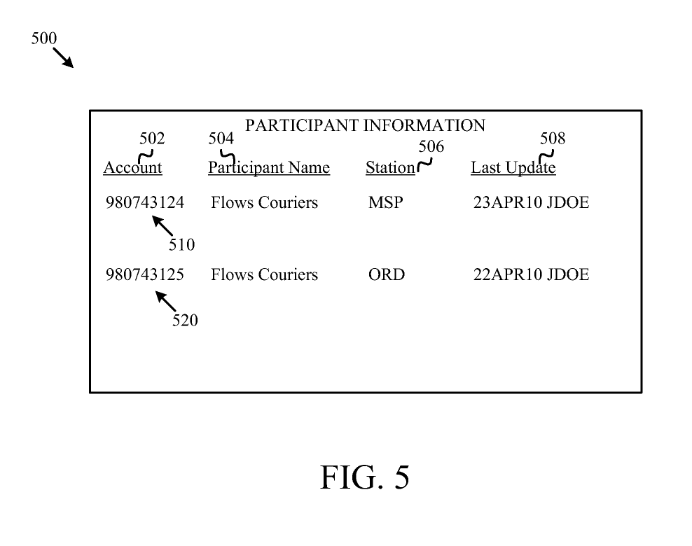

After a search is performed the results may be displayed. FIG. 5 is a block diagram illustrating a display for listing participant information in bilateral agreements according to one embodiment of the disclosure. A display 500 may include columns 502, 504, 506, and 508 listing account number, participant name, station, and last update information, respectively. The account number in column 502 may be, for example, an IATA agent account number including an IATA cargo agent code and a cargo account settlement service address. After a search for participants containing the name “Flows” search results 510 and 520 may be generated. The search result 510 lists an account number “980743124” matching participant “Flows Couriers” at station “MSP,” which was last updated on “23APR10” by user “JDOE.” The search result 520 lists an account number “980743125” matching participant “Flows Couriers” at station “ORD,” which was last updated on “22APR10” by user “JDOE.”

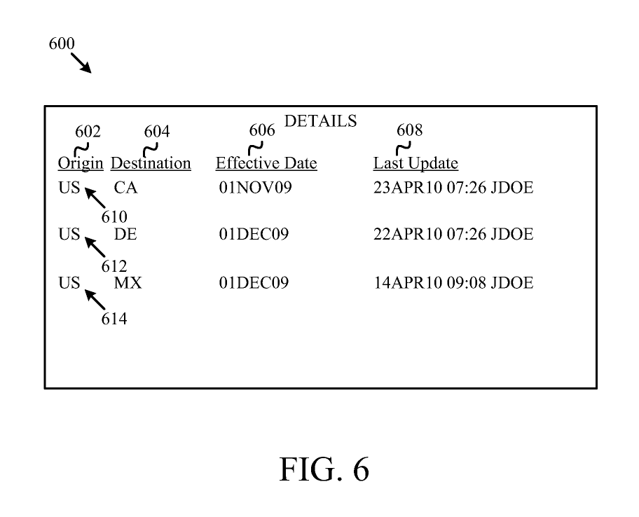

A particular account number may be selected to view bilateral agreements linked to the account number. That is, a user or administrator may select one of the search results 510 and 520 for further information. FIG. 6 is a block diagram illustrating a display for listing details of participant information in bilateral agreements according to one embodiment of the disclosure. A display 600 may include columns 602, 604, 606, and 608 listing origin country, destination country, effective date of agreement, and last update information, respectively. After an account is selected from the display 500 of FIG. 5, bilateral agreement records 610, 612, and 614 may be retrieved.

The bilateral agreement record 610 indicates a bilateral agreement for electronic air waybills is in place for shipments from the United States to Canada effective “01NOV09,” and indicates that the last update to the bilateral agreement record was on “23APR10” at “07:26” by user “JDOE.” The bilateral agreement record 612 indicates a bilateral agreement for electronic air waybills is in place for shipments from the United States to Germany effective “01DEC09,” and indicates that the last update to the bilateral agreement record was on “22APR10” at “07:26” by user “JDOE.” The bilateral agreement record 614 indicates a bilateral agreement for electronic air waybills is in place for shipments from the United States to Mexico effective “01DEC09,” and indicates that the last update to the bilateral agreement record was on “14APR10” at “09:08” by user “JDOE.”

Although not shown, options for updating, creating, or deleting bilateral agreements related to the account selected from the display 500 of FIG. 5 may be present in the display 600 of FIG. 6. An update button may allow the selection of one of the bilateral agreement records 610, 612, and 614 and modification of any of the origination country, destination country, and effective date. The last update information in column 608 of one of the records 610, 612, and 614 may be automatically generated when a user or administrator updates the corresponding record 610, 612, or 614. A create button may allow the insertion of a new bilateral agreement record for the account selected from the display 500 of FIG. 5. After selecting a create button, a user or administrator may be prompted to enter an origin country, a destination country, and an effective date. A delete button may allow the deletion of one of the existing bilateral agreement records 610, 612, and 614. Additionally, options for updating, creating, or deleting accounts in the display 500 of FIG. 5 may be available.

Users and administrators of the bilateral agreement records 610, 612, and 614 may have different privileges. For example, some users may be granted only viewing access for the bilateral agreement records 610, 612, and 614. However, administrators may be granted rights for viewing, updating, deleting, and creating bilateral agreement records. Some administrators may have more limited rights, such as only viewing and updating bilateral agreement records.

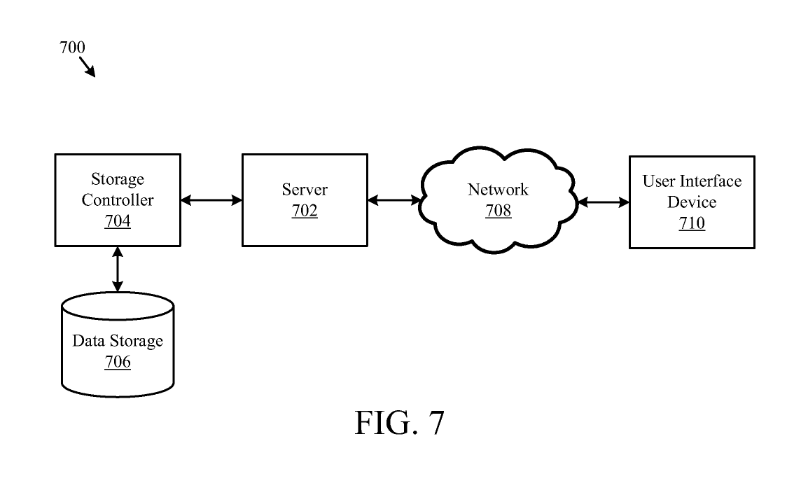

FIG. 7 illustrates one embodiment of a system 700 for an information system, such as a logistics management system (LMS). The system 700 may include a server 702, a data storage device 706, a network 708, and a user interface device 710. The server 702 may be a dedicated server or one server in a cloud computing system. In a further embodiment, the system 700 may include a storage controller 704, or storage server configured to manage data communications between the data storage device 706 and the server 702 or other components in communication with the network 708. In an alternative embodiment, the storage controller 704 may be coupled to the network 708.

In one embodiment, the user interface device 710 is referred to broadly and is intended to encompass a suitable processor-based device such as a desktop computer, a laptop computer, a personal digital assistant (PDA) or tablet computer, a smartphone or other a mobile communication device having access to the network 708. In a further embodiment, the user interface device 710 may access the Internet or other wide area or local area network to access a web application or web service hosted by the server 702 and provide a user interface for enabling a user to enter or receive information.

The network 708 may facilitate communications of data between the server 702 and the user interface device 710. The network 708 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate, one with another.

In one embodiment, the user interface device 710 accesses the server 702 through an intermediate sever (not shown). For example, in a cloud application the user interface device 710 may access an application server. The application server fulfills requests from the user interface device 710 by accessing a database management system (DBMS). In this embodiment, the user interface device 710 may be a computer executing a Java application making requests to a JBOSS server executing on a Linux server, which fulfills the requests by accessing a relational database management system (RDMS) on a mainframe server.

In one embodiment, the server 702 is configured to store databases, pages, tables, and/or records. Additionally, scripts on the server 702 may access data stored in the data storage device 706 via a storage area network (SAN) connection, a LAN, or a data bus. The data storage device 706 may include, for example, a hard disk, including hard disks arranged in an redundant array of independent disks (RAID) array, a tape storage drive comprising a physical or virtual magnetic tape data storage device, or an optical storage device. The data may be arranged in a database and accessible through structured query language (SQL) queries, or other data base query languages or operations.

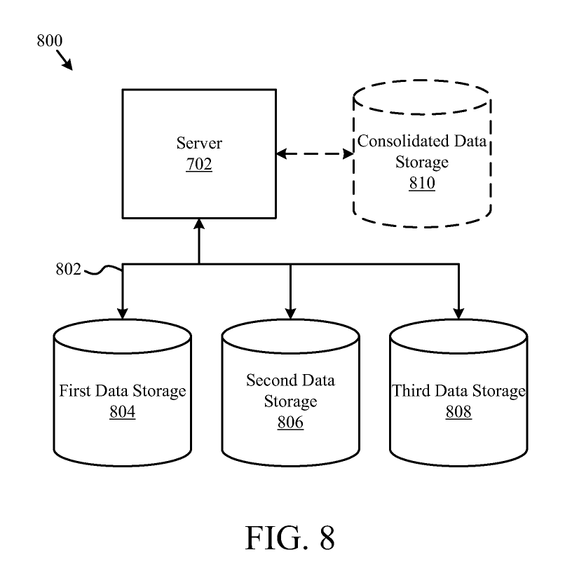

FIG. 8 illustrates one embodiment of a data management system 800 configured to store application parameters and documentation. In one embodiment, the data management system 800 may include the server 702. The server 702 may be coupled to a data-bus 802. In one embodiment, the data management system 800 may also include a first data storage device 804, a second data storage device 806, and/or a third data storage device 808. In further embodiments, the data management system 800 may include additional data storage devices (not shown). In such an embodiment, each data storage device 804, 806, and 808 may each host a separate database that may, in conjunction with the other databases, contain redundant data. Alternatively, a database may be spread across storage devices 804, 806, and 808 using database partitioning or some other mechanism. Alternatively, the storage devices 804, 806, and 808 may be arranged in a RAID configuration for storing a database or databases that may contain redundant data. Data may be stored in the storage devices 804, 806, 808, 810 in a database management system (DBMS), a relational database management system (RDMS), an object oriented database management system (OODMS), an indexed sequential access method (ISAM) database, a multi-sequential access method (MSAM) database, a conference on data systems languages (CODASYL) database, or other database system.

In one embodiment, the server 702 may submit a query to select data from the storage devices 804 and 806. The server 702 may store consolidated data sets in a consolidated data storage device 810. In such an embodiment, the server 702 may refer back to the consolidated data storage device 810 to obtain a set of records. Alternatively, the server 702 may query each of the data storage devices 804, 806, and 808 independently or in a distributed query to obtain the set of data elements. In another alternative embodiment, multiple databases may be stored on a single consolidated data storage device 810.

In various embodiments, the server 702 may communicate with the data storage devices 804, 806, and 808 over the data-bus 802. The data-bus 802 may comprise a storage area network (SAN), a local area network (LAN), or the like. The communication infrastructure may include Ethernet, fibre-channel arbitrated loop (FC-AL), fibre-channel over Ethernet (FCoE), small computer system interface (SCSI), internet small computer system interface (iSCSI), serial advanced technology attachment (SATA), advanced technology attachment (ATA), cloud attached storage, and/or other similar data communication schemes associated with data storage and communication. For example, the server 702 may communicate indirectly with the data storage devices 804, 806, 808, and 810 by first communicating with a storage server (not shown) or the storage controller 704.

The server 702 may include modules for interfacing with the data storage devices 804, 806, 808, and 810, may include modules for interfacing with the network 708, and/or modules for interfacing with a user through the user interface device 710. In a further embodiment, the server 702 may host an engine, application plug-in, or application programming interface (API).

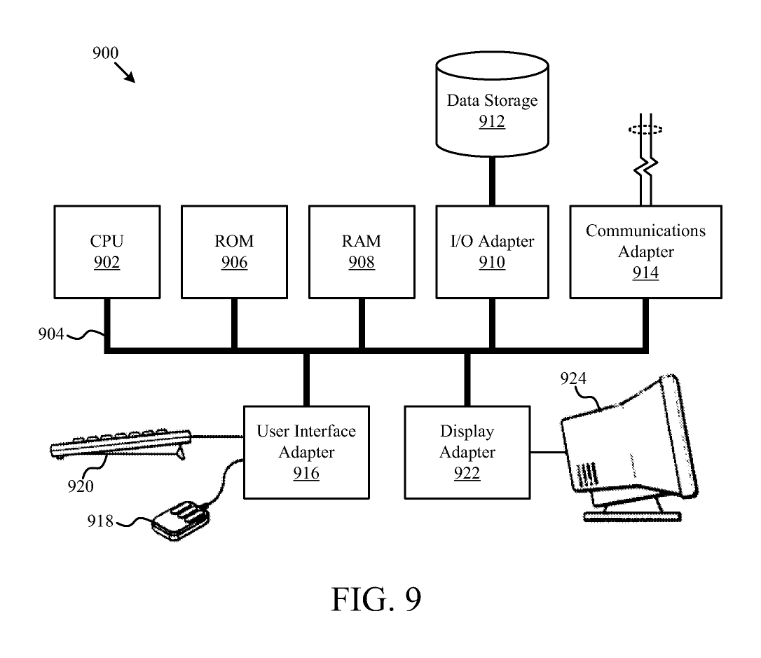

FIG. 9 illustrates a computer system 900 adapted according to certain embodiments of the server 702 and/or the user interface device 710. The central processing unit (“CPU”) 902 is coupled to the system bus 904. The CPU 902 may be a general purpose CPU or microprocessor, graphics processing unit (“GPU”), and/or microcontroller. The present embodiments are not restricted by the architecture of the CPU 902 so long as the CPU 902, whether directly or indirectly, supports the modules and operations as described herein. The CPU 902 may execute the various logical instructions according to the present embodiments.

The computer system 900 also may include random access memory (RAM) 908, which may be synchronous RAM (SRAM), dynamic RAM (DRAM), and/or synchronous dynamic RAM (SDRAM). The computer system 900 may utilize RAM 908 to store the various data structures used by a software application such as databases, tables, and/or records. The computer system 900 may also include read only memory (ROM) 906 which may be PROM, EPROM, EEPROM, optical storage, or the like. The ROM may store configuration information for booting the computer system 900. The RAM 908 and the ROM 906 hold user and system data.

The computer system 900 may also include an input/output (I/O) adapter 910, a communications adapter 914, a user interface adapter 916, and a display adapter 922. The I/O adapter 910 and/or the user interface adapter 916 may, in certain embodiments, enable a user to interact with the computer system 900. In a further embodiment, the display adapter 922 may display a graphical user interface (GUI) associated with a software or web-based application on a display device 924, such as a monitor or touch screen.

The I/O adapter 910 may couple one or more storage devices 912, such as one or more of a hard drive, a flash drive, a compact disc (CD) drive, a floppy disk drive, and a tape drive, to the computer system 900. The communications adapter 914 may be adapted to couple the computer system 900 to the network 708, which may be one or more of a LAN, WAN, and/or the Internet. The communications adapter 914 may be adapted to couple the computer system 900 to a storage device 912. The user interface adapter 916 couples user input devices, such as a keyboard 920, a pointing device 918, and/or a touch screen (not shown) to the computer system 900. The display adapter 922 may be driven by the CPU 902 to control the display on the display device 924.

The applications of the present disclosure are not limited to the architecture of computer system 900. Rather the computer system 900 is provided as an example of one type of computing device that may be adapted to perform the functions of a server 702 and/or the user interface device 710. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving an incoming freight waybill (FWB) message having an origination country and a destination country;
identifying whether a bilateral agreement exists between the origination country and the destination country; and
when a bilateral agreement exists, creating an electronic air waybill (e-AWB) for the incoming FWB message.

2. The method of claim 1, further comprising:
receiving a request to override creating an e-AWB for the incoming FWB message; and
creating a paper air waybill without creating an e-AWB after receiving the request to override creation of an e-AWB.

3. The method of claim 1, in which the e-AWB is generated within a logistics management system.

4. The method of claim 1, further comprising:
receiving an account number, a destination country, and an origin country for which e-AWBs may be allowed; and
building, in a database, a table comprising a record having the account number, the destination country, and the origin country,
in which the step of identifying whether a bilateral agreement exists comprises searching the database for an account number on the incoming freight waybill.

5. The method of claim 4, in which the database is at least one of a database management system and a relational database management system.

6. The method of claim 1, further comprising when no bilateral agreement exists, creating a paper AWB for the incoming FWB message.

7. The method of claim 1, in which the bilateral agreement indicates the origination country and the destination country ratified an identical treaty.

8. A computer program product, comprising:
a non-transitory computer readable medium comprising:
code to receive an incoming freight waybill (FWB) message having an origination country and a destination country;
code to identify whether a bilateral agreement exists between the origination country and the destination country; and
code to, when a bilateral agreement exists, create an electronic air waybills (e-AWB) for the incoming FWB message.

9. The computer program product of claim 8, in which the medium further comprises:
code to receive a request to override creation of an e-AWB for the incoming FWB message; and
code to create a paper air waybill without creating an e-AWB when the request is received to override creating an e-AWB.

10. The computer program product of claim 8, in which the e-AWB is generated within a logistics management system.

11. The computer program product of claim 8, in which the medium further comprises:
code to receive an account number, a destination country, and an origin country for which e-AWBs may be allowed; and
code to build, in a database, a table comprising a record having the account number, the destination country, and the origin country,
in which the code to identify whether a bilateral agreement exists comprises searching the database for an account number on the incoming freight waybill.

12. The computer program product of claim 11, in which the database is at least one of a database management system and a relational database management system.

13. The computer program product of claim 8, in which the medium further comprises code to, when no bilateral agreement exists, create a paper AWB for the incoming FWB message.

14. The computer program product of claim 8, in which the bilateral agreement indicates the origination country and the destination country ratified an identical treaty.

15. A system, comprising:
a memory and at least one processor in which the at least one processor is coupled to the memory and the at least one processor is configured:
to receive an incoming freight waybill (FWB) message having an origination country and a destination country;
to identify whether a bilateral agreement exists between the origination country and the destination country; and
to, when a bilateral agreement exists, create an electronic air waybills (e-AWB) for the incoming FWB message.

16. The system of claim 15, in which the at least one processor is further configured:
to receive a request to override creation of an e-AWB for the incoming FWB message; and
to create a paper air waybill without creating an e-AWB when the request is received to override creating an e-AWB.

17. The system of claim 15, in which the at least one processor is further configured:
to receive an account number, a destination country, and an origin country for which e-AWBs may be allowed; and
to build, in a database stored in the memory, a table comprising a record having the account number, the destination country, and the origin country,
in which identifying whether a bilateral agreement exists comprises searching the database for an account number on the incoming freight waybill.

18. The system of claim 17, in which the database is at least one of a database management system and a relational database management system.

19. The system of claim 15, in which the at least one processor is further configured to, when no bilateral agreement exists, create a paper AWB for the incoming FWB message.

20. The system of claim 15, in which the bilateral agreement indicates the origination country and the destination country ratified an identical treaty.
